(19) United States
(12) Patent Application Publication
(10) Pub. No.: US 2017/0232891 A1
(43) Pub. Date: Aug. 17, 2017

(54) METHOD AND DEVICE FOR OPERATING A VEHICLE AND A PARKING LOT

(71) Applicant: Robert Bosch GmbH, Stuttgart (DE)

(72) Inventor: Stefan Nordbruch, Kornwestheim (DE)

(21) Appl. No.: 15/521,829

(22) PCT Filed: Sep. 29, 2015
(86) PCT No.: PCT/EP2015/072320

§ 371 Date: Apr. 25, 2017

(30) Foreign Application Priority Data
Oct. 27, 2014 (DE) 10 2014 221 759.8

(51) Int. Cl. B60Q 9/00; G05D 1/02; E04H 6/42; B60Q 5/00; B60Q 1/46; G05D 1/00; G08G 1/015

(52) U.S. Cl. CPC B60Q 9/002; G05D 1/0088; G05D 1/0212; G08G 1/015; B60Q 5/005; B60Q 1/46; E04H 6/422

(57) ABSTRACT

A method for operating a vehicle, the vehicle driving autonomously in a parking lot and emitting at least one signal to its environment during its autonomous travel to signal to the environment that it is driving autonomously. The invention furthermore relates to a method for operating a parking lot, to a device for operating a vehicle, a device for operating a parking lot, to a vehicle, a device, a parking lot, and to a computer program.

### FIELD OF THE INVENTION

The present invention relates to a method and a device for operating a vehicle. Furthermore, the present invention relates to a method and a device for operating a parking lot. In addition, the present invention relates to a vehicle and to a parking lot. Moreover, the present invention relates to a computer program.

### BACKGROUND INFORMATION

In fully automated (autonomous) so-called valet parking, a driver parks a vehicle at a drop-off point, e.g., in front of a parking garage, and from there the vehicle drives on its own to a parking position/parking bay and back again to the drop-off point.

For safety-related reasons, there is consequently a need to inform people and/or vehicles that are located in the environment of the autonomously driving vehicle of the fact that the vehicle is driving autonomously.

### SUMMARY OF THE INVENTION

Therefore, an objective on which the present invention is based may be seen as providing a method for operating a vehicle that allows persons and/or vehicles in the environment of the autonomously driving vehicle to obtain knowledge of the fact that the vehicle is driving autonomously.

The objective on which the present invention is based may also be seen as providing a corresponding device for operating a vehicle, a corresponding method for operating a parking lot, a corresponding device for operating a parking lot, a corresponding vehicle, a corresponding parking lot, and a corresponding computer program.

These objectives are achieved by the respective subject matter of the descriptions herein. Advantageous further refinements of the present invention are the subject matter of the respective further descriptions herein.

According to one aspect, a method for operating a vehicle is provided,
in which the vehicle drives in a parking lot autonomously, and
during its autonomous travel, emits at least one signal to its environment in order to signal to the environment that it is driving in an autonomous manner.

According to one aspect, a method for operating a parking lot is provided,
in which a signaling measure is executed,
so that it is signaled to an environment of a vehicle driving autonomously in the parking lot that the vehicle is driving in the parking lot in an autonomous manner.

According to a further aspect, a device for operating a vehicle is provided, which includes
a guidance device for the autonomous guidance of the vehicle,
a signaling device for emitting a signal, and
a control device, which is configured to control the signaling device during an autonomous travel of the vehicle in such a way that the signaling device emits at least one signal to an environment of the vehicle in order to signal to the environment that the vehicle is driving autonomously.

According to a still further aspect, a vehicle is provided, which is configured to execute the method for operating a vehicle.

According to a still further aspect, a device for operating a parking lot is provided, which includes
an infrastructure, which is developed to carry out a signaling measure
in order to signal to an environment of a vehicle driving autonomously in the parking lot that the vehicle is driving in the parking lot in an autonomous manner.

According to a still further aspect, a parking lot is provided, which is configured to execute the method for operating a parking lot.

According to a still further aspect, a computer program is provided, which includes program code for executing the method for operating a vehicle and/or for operating a parking lot when the computer program is executed on a computer.

Thus, the present invention particularly encompasses the idea of signaling to an environment of the vehicle that the vehicle is driving in the parking lot in an autonomous manner, for instance in that the vehicle emits at least one signal to its environment. In particular, this is done also by executing a corresponding signaling measure. Thus, the environment of the vehicle is advantageously able to obtain knowledge of the fact that an autonomously driving vehicle is underway in the parking lot. The environment, i.e. people and/or further vehicles, for example, is then able to appropriately adapt its respective behavior to this situation. The safety of the people and the other vehicles can thereby be increased in an advantageous manner. Especially a collision risk is advantageously able to be reduced or even entirely avoided.

As a result, it is advantageously made clear to the environment of the vehicle that the vehicle is moving autonomously and may therefore possibly exhibit a different behavior than a vehicle that is manually controlled by a driver. The behavior of the environment is then able to be adapted accordingly, and the risk of an accident can be reduced or avoided. In particular, the safety may be increased. Furthermore, the safety of persons and manually controlled vehicles is able to be improved, in particular.

According to a specific embodiment, the emission of the at least one signal includes that a signal is transmitted via a communications network. This particularly offers the technical advantage that users of the communications network are able to obtain knowledge of the fact that the vehicle is driving autonomously.

According to a specific embodiment, the signal includes a message, such as: “Here comes an AVP vehicle.”

According to a specific embodiment, the signal is an electronic signal.

In another specific embodiment, it is provided that multiple signals be emitted, which, in particular, have the same form or may have a different form.

According to a further specific embodiment, it is provided that the signal be emitted when an environmental sensor system of the vehicle has detected an object in the environment of the vehicle and/or when the vehicle receives an off-board warning signal that includes the information that an object is located in the environment of the vehicle. This particularly provides the technical advantage that it is signaled to the object in the environment of the vehicle that it is located in the environment of an autonomously driving vehicle. This is of great relevance especially when the object is a living object, e.g., a person or an animal. If the object is a vehicle, it is advantageously signaled to the driver of the vehicle that the driver with his vehicle is located in the environment of the autonomously driving vehicle. If the further vehicle is an autonomously driving vehicle as well, then it will also be signaled to this further autonomously driving vehicle that an autonomously driving vehicle is located in its vicinity. The further autonomously driving vehicle is then able to adapt its vehicle control accordingly.

According to another specific embodiment, the emitting of the at least one signal includes the emitting of a horn signal from a vehicle horn and/or a light signal from an external lighting device of the vehicle. In particular regular honking, i.e. a regular emission of a honking signal, is provided. In other words, the horn signal is emitted at a predefined frequency.

The light signal is emitted by an element that is part of the external lighting device of the vehicle, in particular. The external lighting system of the vehicle thus includes the following elements, for instance: high beam, low beam, side-marker lights, parking lamps, turn signal lamps, fog lamps, front cornering lamps, wide beams, daytime running lamps, front identification lamps, rear lights, tail lights, brake lights, reflectors, license plate lamps, rear fog lamps, backup lamps, side marker lamps, side turn signal lamps, as well as special emergency signals. Thus, it is provided, in particular, that at least one of the aforementioned elements of the external lighting systems of the vehicle emits a light signal as the signal that is meant to signal to the environment that the vehicle is driving in an autonomous manner.

According to a specific embodiment, it is provided that the light signal be emitted at a predefined frequency, i.e. especially regularly.

According to a further specific embodiment, if the light signal is a light signal from a hazard warning flasher of the vehicle, emitted by a turn signal lamp of the external lighting system of the vehicle, then the turn signal lamp is switched off for a predefined time prior to a parking operation or an unparking operation and/or prior to a turning operation of the vehicle; this is done in order to be able to signal, after the predefined time has elapsed, a change in direction of the vehicle, allocated to the parking or the unparking operation or the turning operation, with the aid of the turn signal lamp.

This particularly achieves the technical advantage that on the one hand, a turn signal lamp may be used to signal to the environment, with the aid of the hazard lamp function, that the vehicle is traveling autonomously; for another, it may be used to indicate a change in direction when the autonomously driving vehicle executes a turn and/or parks or leaves a parking position. Thus, it allows for an efficient use of the turn signal lamp.

According to a further specific embodiment, the signal is a positional signal, which includes the information of a current position of the vehicle, and/or which includes a route signal that includes the information of a planned route of the vehicle in the parking lot.

This particularly provides the technical advantage that the environment of the vehicle is able to obtain information as to where the autonomously driving vehicle is currently located and/or which route the vehicle intends to travel in the parking lot. As a result, a corresponding behavior of the environment is able to be even better adapted to this situation, which may advantageously improve the safety.

According to another specific embodiment, the execution of the signaling measure includes that before the autonomous driving commences, a light system is placed on the vehicle for the emission of a light signal. In other words, the light system may be used to emit a light signal to the environment of the vehicle so that the environment is then advantageously able to obtain knowledge of the fact that an autonomously driving vehicle is traveling in the parking lot.

According to a specific embodiment, it is provided that the light system be removed from the vehicle again after the autonomous travel has been concluded.

According to one specific embodiment, the light system is controlled with the aid of the device for operating a parking lot, in particular with the aid of the control device. For example, the device is able to activate the light system when the vehicle is driving autonomously in the parking lot. The device may deactivate the light system when the vehicle is parking or when it leaves the parking position autonomously.

For example, the control is carried out via a communications network such as a WLAN. This means that corresponding control signals are transmitted to the light system via the communications network.

The autonomous driving starts at the drop-off position according to a specific embodiment.

The autonomous driving ends at the drop-off position according to a specific embodiment. In the meantime the vehicle has autonomously driven to the parking position. In other words, according to a specific embodiment, the light system is placed on the vehicle for what is termed valet parking before the vehicle drives to the parking position; when the vehicle has driven back from the parking position to the drop-off point again, the light system may be removed again from the vehicle.

In another specific embodiment, the execution of the signaling measure includes that the vehicle is illuminated while it is autonomously driving in the parking lot, at least during a portion of the autonomous driving. The vehicle may be illuminated during the entire autonomous travel. Persons and other vehicles in the environment of the autonomously driving vehicle thus immediately recognize that the illuminated vehicle is a vehicle that requires particular attention because a vehicle is usually not illuminated in such a way without a reason. This specific embodiment in particular offers the advantage that persons or vehicles in the environment of the vehicle need not necessarily be users of a communications network. In particular, this specific embodiment has the advantage that the autonomously driving vehicle is not required to transmit corresponding signals to its environment on its own.

In another specific embodiment, the execution of the signaling measure includes the emission of an acoustic signal that is able to acoustically signal to persons that an autonomously driving vehicle is moving in the parking lot. This particularly offers the technical advantage that even persons who are not in the visual range of the autonomously driving vehicle or who have limited vision are able to be informed that they are moving in the environment of an autonomously driving vehicle. For example, the emitting of an acoustic signal may include a loudspeaker announcement. Such an announcement may be the following, for instance: “Attention, an AVP is traveling on level 3.”

According to another specific embodiment, the execution of the signaling measure includes that at least an information sign and/or a warning sign is placed on the vehicle before the autonomous driving commences. Similar to the specific embodiment regarding the light system, here too it is specifically provided that the information sign and/or the warning sign be removed again after the autonomous driving has been concluded.

According to one specific embodiment, the vehicle is equipped with an environmental sensor system. Such an environmental sensor system, for example, includes one or more environmental sensor(s). Either individually or in combination, the following environmental sensors are provided as an example of such environmental sensors: radar sensor, ultrasonic sensor, laser sensor, video sensor and lidar sensor.

Autonomously within the meaning of the present invention means in particular that the vehicle navigates on its own, i.e. without an intervention by a driver. That is to say, the vehicle drives in the parking lot by itself without a driver having to control the vehicle or having to be present in the vehicle for this purpose. In particular, this means that the guidance device for the navigation controls the vehicle autonomously. A guidance in particular includes a lateral and/or a longitudinal guidance of the vehicle. Such an autonomously driving vehicle, which is able to park and unpark automatically, is referred to as an AVP vehicle, for instance. AVP stands for “automatic valet parking” and may be translated as “automatic parking operation”. Vehicles without this functionality are referred to as normal vehicles, for example.

According to a specific embodiment, the vehicle autonomously drives from a drop-off position to a parking position.

In another specific embodiment, the vehicle drives autonomously from the parking position to the drop-off position.

A drop-off position within the meaning of the present invention is a position at which a driver is able to leave his vehicle for an autonomous parking operation or at which he may pick up his vehicle again at a later point in time.

A parking position within the meaning of the present invention is a position at which the vehicle is meant to park autonomously.

A parking lot within the meaning of the present invention may also be referred to as a parking area and is used as a parking area for vehicles. Thus, the parking lot particularly forms a continuous area that has a plurality of parking positions (in case of a parking lot on private property) or parking slots (in case of a parking lot on public property). The parking lot according to a specific embodiment may be part of a parking structure. The parking lot, in particular, is part of a garage.

A parking-lot management system may coordinate the allocation of the parking positions and in particular provides the required information (e.g., a digital map of the parking position, in particular of the parking garage) to the autonomous vehicles.

According to a specific embodiment, the communications network includes a WLAN and/or a mobile telephony network.

In the following text the present invention will be discussed in greater detail on the basis of the exemplary embodiments.

### BRIEF DESCRIPTION OF THE DRAWINGS

FIG. 1 shows a flow diagram of a method for operating a vehicle.

FIG. 2 shows a flow diagram of a method for operating a parking lot.

FIG. 3 shows a device for operating a vehicle.

FIG. 4 shows a vehicle.

FIG. 5 shows a device for operating a parking lot.

FIG. 6 shows a parking lot.

### DETAILED DESCRIPTION

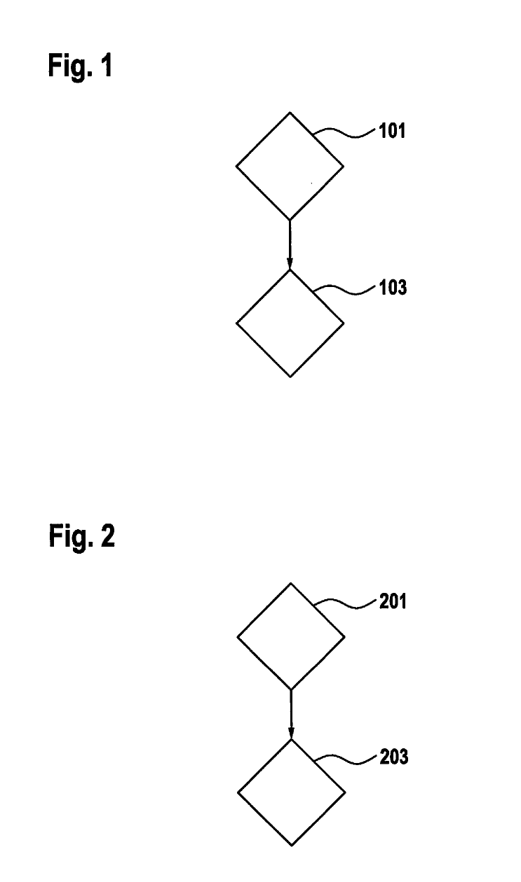

FIG. 1 shows a flow diagram of a method for operating a vehicle.

In a step 101, the vehicle drives in a parking lot in an autonomous manner. In a step 103, the vehicle sends at least one signal to its environment during its autonomous travel in order to signal to the environment that it is driving autonomously.

FIG. 2 shows a flow diagram of a method for operating a parking lot.

In a step 201, a signaling measure is carried out so that, in a step 203, it is signaled to an environment of a vehicle driving autonomously in the parking lot that the vehicle is driving in an autonomous manner in the parking lot.

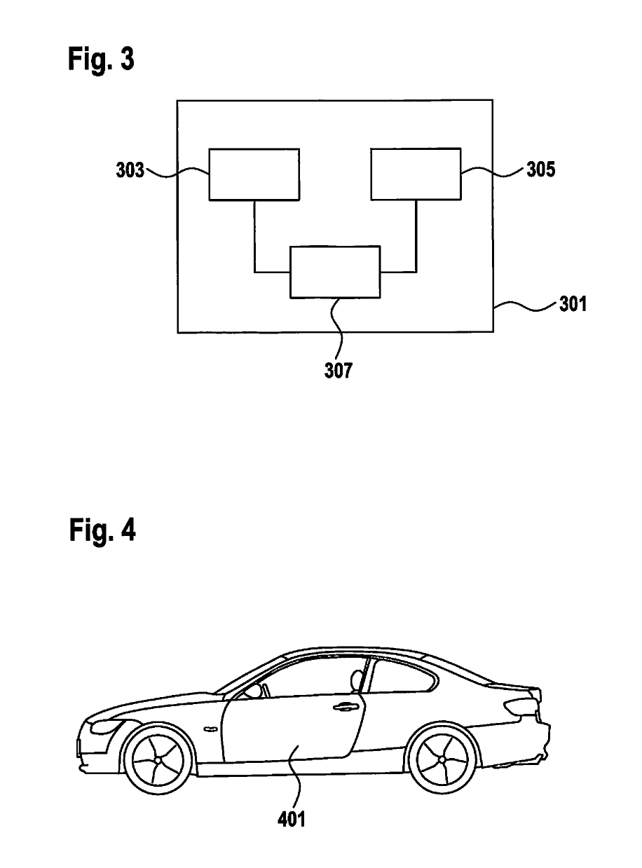

FIG. 3 shows a device 301 for operating a vehicle. Device 301 includes a guidance device 303, which is configured to guide the vehicle autonomously, in particular to guide it in a parking lot. Device 301 furthermore includes a signaling device 305 for emitting a signal. In addition, device 301 includes a control device 307, which is configured to control signaling device 305 during the autonomous travel of the vehicle in such a way that it emits at least one signal to an environment of the vehicle in order to signal to the environment that the vehicle is driving autonomously. Signaling device 305, for example, includes a vehicle horn and/or a vehicle external lighting system.

In other words, if control unit 307 detects or senses that the vehicle is driving in the parking lot autonomously with the aid of guidance device 303, control device 307 controls signaling device 305 accordingly.

FIG. 4 shows a vehicle 401, which is configured to carry out the method for operating a vehicle. In particular, vehicle 401 includes device 301 from FIG. 3. Vehicle 401, for example, includes an environmental sensor system for sensing an environment of vehicle 401. The sensed environment may be used as the basis for guiding the vehicle with the aid of guidance device 303.

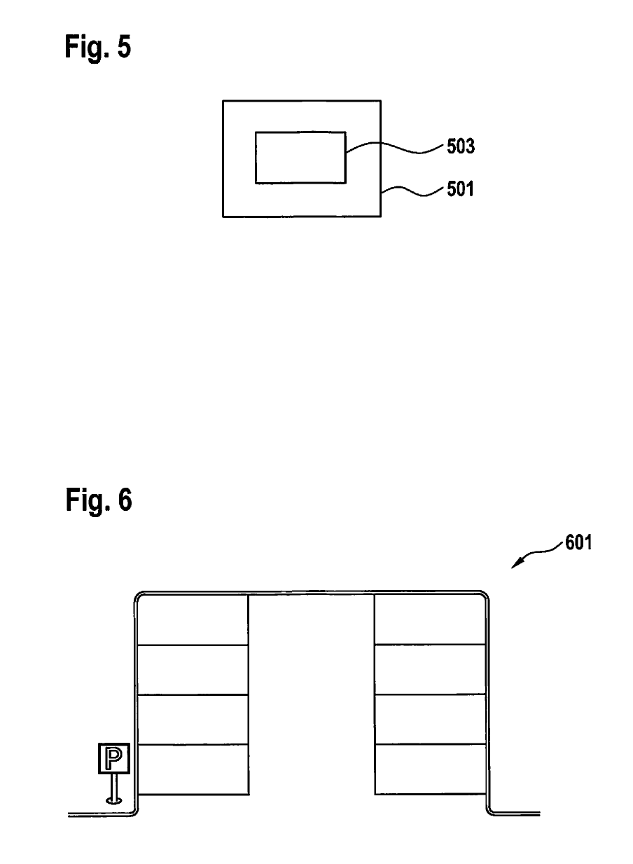

FIG. 5 shows a device 501 for operating a parking lot.

Device 501 includes an infrastructure 503, which is configured to carry out a signaling measure in order to signal to an environment of a vehicle driving autonomously in a parking lot that the vehicle is driving in the parking lot in an autonomous manner.

In one specific embodiment, infrastructure 503 includes a lighting system, which is configured to illuminate the vehicle while it is driving autonomously in the parking lot during a portion of the autonomous travel and to illuminate it specifically during the entire autonomous travel.

In another specific embodiment, the infrastructure includes a loudspeaker system for emitting an acoustic signal, in particular an acoustic announcement.

FIG. 6 shows a parking lot 601, which is set up to execute the method for operating a parking lot. Parking lot 601 includes device 501 from FIG. 5, for instance.

That is to say, the present invention specifically encompasses the thought of making it clear to an environment of an autonomously driving vehicle that the vehicle is traveling in an autonomous manner (also referred to as fully automatic), or in other words, is driving in the parking lot autonomously, in particular. This is done especially when the autonomously traveling vehicle, which particularly is an AVP vehicle, is driving autonomously from the drop-off position (also known as drop-off zone) to the parking position, and especially when the autonomously driving vehicle is parking in the parking position or is leaving the parking position, and in particular also when it is driving autonomously from the parking position back to the drop-off zone or the drop-off position.

Thus, in order to make it clear to the environment of the vehicle that the vehicle is moving in the parking lot in an autonomous manner, the following actions or signaling measures are used for the identification, either individually or in any possible combination:
A regular operation of the horn by the AVP vehicle;
Use of the horn if the AVP vehicle detects an object (such as a vehicle, person, animal or “unknown”)
   with the aid of the own vehicle sensor system (also termed environmental sensor system) and/or
   with the aid of the parking lot management system, which in turns informs the vehicle accordingly.
Regular “flashing” of the vehicle lights by the AVP vehicle;
“Flashing” of the vehicle lights when the AVP vehicle detects an object (such as a vehicle, person, animal or “unknown”)
   with the aid of its own vehicle sensor system,
   the parking lot management system, which in turn informs the vehicle accordingly,
Emission of an electronic signal (e.g., via WLAN) with a message such as “Here comes an AVP vehicle” (which may include the current position and the scheduled path or route).
Temporarily mounting a warning light or an information light (e.g., on the roof) beginning at the drop-off zone, which is able to be switched off by the parking lot management system, which may be during the parking operation, e.g., via WLAN.
An “illumination” of the AVP vehicle by a parking lot infrastructure (e.g., lighting means that are controlled by the parking lot management (generally the device for operating a parking lot, in particular the control device)),
Announcements by loudspeaker by the parking lot management system (e.g., “Attention, an AVP vehicle is underway on level 3”)
Mounting one or more magnetic, and which may be very noticeable information/warning sign(s) on the AVP vehicle at the drop-off zone (e.g., with the writing “Attention, AVP vehicle”).
Turned-on hazard flashing light in the AVP vehicle during the autonomous driving.

Prior to a parking operation or prior to a turning operation, the hazard flashing light may be turned off for a period of time so that the AVP vehicle is able to indicate the change in direction by the blinker.

1-16. (canceled)

17. A method for operating a vehicle, the method comprising:
providing for the vehicle to drive autonomously in a parking lot; and
emitting at least one signal to an environment of the vehicle during its autonomous travel to signal to the environment that the vehicle is driving in an autonomous manner.

18. The method of claim 17, wherein the emitting of the at least one signal includes a signal being emitted via a communications network.

19. The method of claim 17, wherein the signal is emitted if at least one of (i) an environmental sensor system of the vehicle has detected an object in the environment of the vehicle, and (ii) the vehicle receives an off-board warning signal which includes the information that an object is located in the environment of the vehicle.

20. The method of claim 17, wherein the emitting of the at least one signal includes at least one of a horn signal of a vehicle horn and a light signal of an external lighting system of the vehicle is emitted.

21. The method of claim 20, wherein when the light signal is a light signal of a hazard flashing light of the vehicle emitted by a turn signal lamp of the external lighting system of the vehicle, the turn signal lamp is switched off for a predefined time prior to a parking or an unparking operation and/or prior to a turning operation of the vehicle so that, once the predefined time has elapsed, a change in direction of the vehicle, allocated to the parking or unparking operation or to the turning operation, is able to be signaled to the environment with the turn signal lamp.

22. The method of claim 17, wherein the signal is a positional signal which includes the information of a current position of the vehicle and/or which includes a route signal that includes the information of a planned route of the vehicle in the parking lot.

23. A method for operating a parking lot, the method comprising:
performing a signaling measure;
wherein the signaling measure is signaled to an environment of a vehicle driving autonomously in the parking lot that the vehicle is driving in the parking lot in an autonomous manner.

24. The method of claim 23, wherein the execution of the signaling measure provides that before the autonomous driving commences, a lighting system for emitting a light signal is mounted on the vehicle.

25. The method of claim 23, wherein the execution of the signaling measure provides that the vehicle is illuminated during its autonomous travel in the parking lot, at least during a portion of the autonomous travel.

26. The method of claim 23, wherein the execution of the signaling measure provides that an acoustic signal is emitted which is able to acoustically signal to persons that the autonomously driving vehicle is driving in the parking lot.

27. The method of claim 23, wherein the execution of the signaling measure provides that at least an information sign and/or a warning sign is/are mounted on the vehicle before the autonomous travel commences.

28. A device for operating a vehicle, comprising:
a guidance device for autonomously guiding the vehicle;
a signaling device for emitting a signal; and
a control device, which is configured to control the signaling device during an autonomous travel of the vehicle so that it emits at least one signal to an environment of the vehicle to signal to the environment that the vehicle is driving in an autonomous manner.

29. A vehicle, comprising:
a device for operating the vehicle, including:
a guidance device for autonomously guiding the vehicle;
a signaling device for emitting a signal; and
a control device, which is configured to control the signaling device during an autonomous travel of the vehicle so that it emits at least one signal to an environment of the vehicle to signal to the environment that the vehicle is driving in an autonomous manner.

30. A device for operating a parking lot, comprising:
an infrastructure configured to execute a signaling measure;
wherein the signaling measure includes signaling to an environment of a vehicle driving autonomously in the parking lot that the vehicle is driving in the parking lot in an autonomous manner.

31. A parking lot, comprising:
an apparatus configured for operating a parking lot by performing the following:
performing a signaling measure;
wherein the signaling measure is signaled to an environment of a vehicle driving autonomously in the parking lot that the vehicle is driving in the parking lot in an autonomous manner.

32. A computer readable medium having a computer program, which is executable by a processor, comprising:
a program code arrangement having program code for operating a vehicle, by performing the following:
providing for the vehicle to drive autonomously in a parking lot; and
emitting at least one signal to an environment of the vehicle during its autonomous travel to signal to the environment that the vehicle is driving in an autonomous manner.
